(19) United States
(12) Patent Application Publication
(10) Pub. No.: US 2014/0375689 A1
(43) Pub. Date: Dec. 25, 2014

(54) IMAGE PROCESSING DEVICE AND COMPUTER READABLE MEDIUM

(71) Applicant: CASIO COMPUTER CO., LTD., Tokyo (JP)

(72) Inventor: Tetsuya HANDA, Tokyo (JP)

(73) Assignee: CASIO COMPUTER CO., LTD., Tokyo (JP)

(21) Appl. No.: 14/310,044

(22) Filed: Jun. 20, 2014

(30) Foreign Application Priority Data
Jun. 20, 2013 (JP) 2013-129368

(51) Int. Cl. G06T 19/00

(52) U.S. Cl. CPC G06T 19/006
USPC 345/633

(57) ABSTRACT

Disclosed is an image processing device including an image pickup unit, a display unit which displays a picked up image obtained by the image pickup unit, a frame-in frame-out recognition unit which recognizes that a predetermined marker framed-in in or framed-out from a screen of the display unit, a frame-in frame-out direction recognition unit which recognizes a frame-in direction or a frame-out direction of the marker and a control unit which makes the display unit perform a predetermined display according to the frame-in direction or the frame-out direction of the marker.

### BACKGROUND OF THE INVENTION

1. Field of the Invention

The present invention relates to an image processing device and a computer readable medium.

2. Description of Related Art

In recent years, an augmented reality system (AR system) using an augmented reality technique to superimpose a virtual object on a real space so as if the virtual object really exists is becoming widely used. For example, there is known an augmented reality system where, when an image including an AR marker is picked up, a virtual object image is combined in the picked up image according to the type of the AR marker and the arranged position of the AR marker.

However, in such augmented reality system using markers, a number of markers corresponding to the individual types of virtual object images which are to be displayed are needed, for example. In view of this, for example, JP 2005-250950 discloses a technique to select the virtual object to be display from a plurality of types of virtual objects without carrying around the printed matters of a plurality of markers by making a plurality of types of markers and virtual object images stored in a marker posting mobile terminal so that they are respectively associated and displaying the marker selected by a user in the marker posing mobile terminal.

### SUMMARY OF THE INVENTION

In the technique of JP 2005-250950, one AR marker is associated with one virtual object image and a user needs to perform a selection operation to switch the type of the marker to be displayed in the marker posting mobile terminal in order to display another virtual object image.

An object of the present invention is to perform a plurality of different displays using one marker.

In order to solve the above problems, according to a first aspect of the present invention an image processing device includes an image pickup unit, a display unit which displays a picked up image obtained by the image pickup unit, a frame-in recognition unit which recognizes that a predetermined marker framed-in in a screen of the display unit, a frame-in direction recognition unit which recognizes a frame-in direction of the marker, and a control unit which makes the display unit perform a predetermined display according to the frame-in direction of the marker.

According to a second aspect of the present invention, an image processing device includes an image pickup unit, a display unit which displays a picked up image obtained by the image pickup unit, a frame-in recognition unit which recognizes that a predetermined marker framed-in in a screen of the display unit, a frame-out recognition unit which recognizes that the marker framed-out from the screen of the display unit, a frame-out direction recognition unit which recognizes a frame-out direction of the marker, a storage unit which stores the frame-out direction of the marker, and a control unit which makes the display unit perform a predetermined display according to the frame-out direction of the marker stored in the storage unit when frame-in of the marker is recognized after frame-out of the marker is recognized.

According to a third aspect of the present invention, an image processing device includes an image pickup unit, a display unit which displays a picked up image obtained by the image pickup unit, a marker recognition unit which recognizes a predetermined marker in a screen of the display unit, a frame-out direction recognition unit which recognizes a frame-out direction of the marker, and a control unit which makes the display unit perform a predetermined display according to the frame-out direction of the marker.

According to the present invention, a plurality of different displays can be performed with one marker.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a block diagram showing a functional configuration of an image processing device according to an embodiment;

FIG. 2 is a drawing showing an example of data storage in a frame-in/frame-out information storage unit;

FIG. 3 is a drawing showing an example of data storage in a movement pattern data base;

FIG. 4 is a flowchart showing a display control process which is executed by the CPU in FIG. 1;

FIG. 5 is a drawing for explaining a recognition method of frame-in direction and frame-out direction of an AR marker;

FIG. 6A is a drawing showing an example of a display movement according to the display control process;

FIG. 6B is a drawing showing an example of a display movement according to the display control process;

FIG. 6C is a drawing showing an example of a display movement according to the display control process;

FIG. 6D is a drawing showing an example of a display movement according to the display control process;

FIG. 6E is a drawing showing an example of a display movement according to the display control process;

FIG. 6F is a drawing showing an example of a display movement according to the display control process;

FIG. 7 is a drawing showing a frame-in/frame-out operation method in a portable terminal which is to be held in a hand; and

FIG. 8 is a drawing showing a frame-in/frame-out operation method in eye-glasses type HMD.

### DESCRIPTION OF THE PREFERRED EMBODIMENTS

Hereinafter, preferable embodiments according to the present invention will be described in detail with reference to the drawings. However, the present invention is not limited to the examples showing in the drawings.

### <Configuration of the Image Processing Device 1>

First, a configuration of the image processing device 1 according to the embodiment will be described.

As for the image processing device 1, portable terminals such as smartphones, tablet terminals, notebook type PCs (Personal Computers), handy terminals, etc. are applicable.

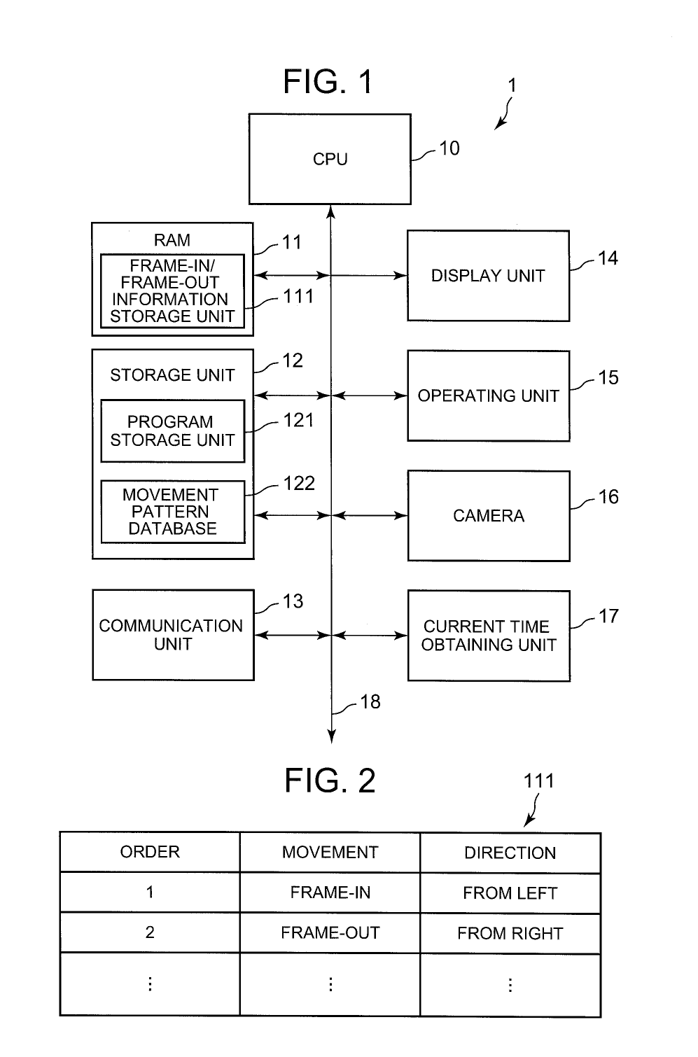

FIG. 1 shows a functional configuration example of the image processing apparatus 1. As shown in FIG. 1, the image processing apparatus 1 includes a CPU (Central Processing Unit) 10, a RAM (Random Access Memory) 11, a storage unit 12, a communication unit 13, a display unit 14, an operating unit 15, a camera 16, a current time obtaining unit 17, etc. These components are connected to each other by a bus 18.

The CPU 10 reads out a program stored in the storage unit 12, opens it in a work area in the RAM 11 and execute each process, for example, the after-mentioned display control process in accordance with the opened program. By executing the display control process, the CPU 10 functions as a frame-in recognition unit, a frame-in direction recognition unit, a frame-out recognition unit, a frame-out direction recognition unit, a marker recognition unit and a control unit.

The RAM 11 is a volatile memory and includes a work area for storing various types of programs which are to be executed by the CPU 10, data according to these programs and the like.

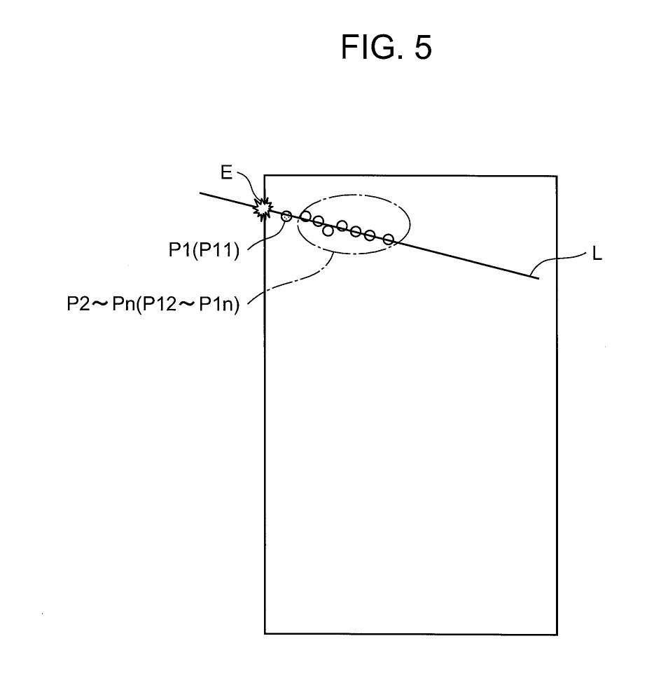

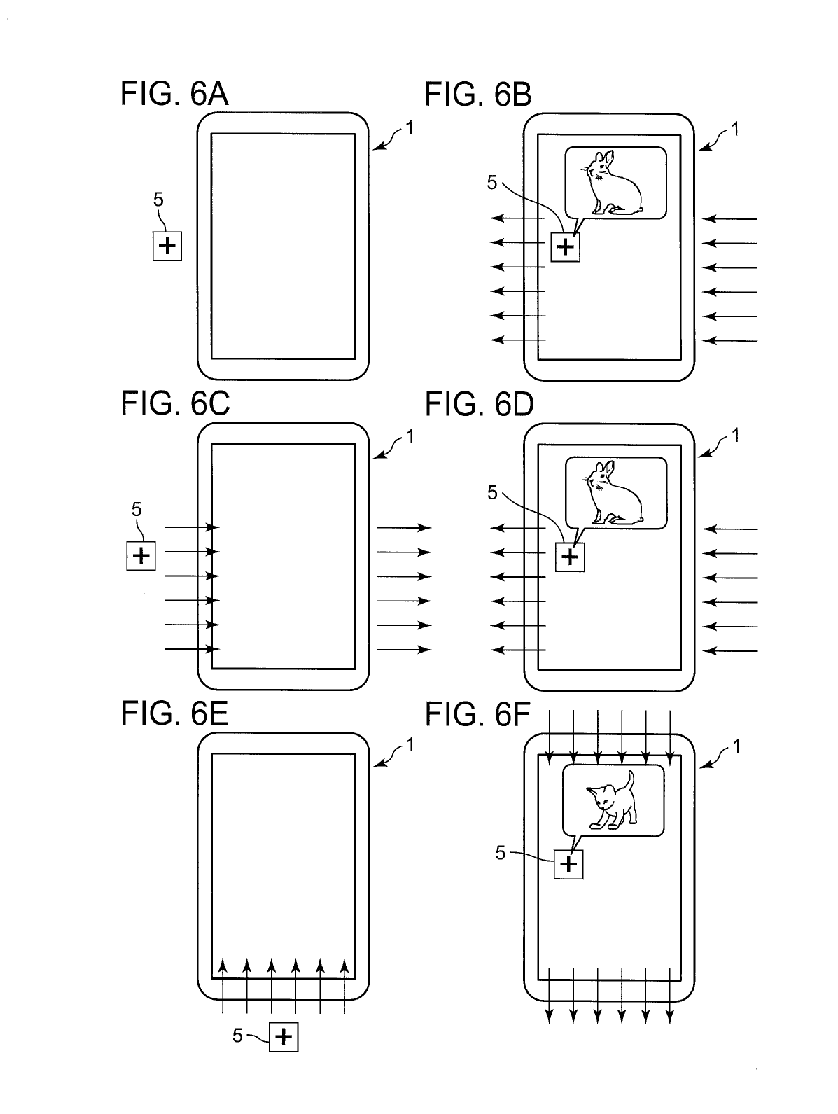

The RAM 11 also includes a frame-in/frame-out information storage unit 111 for storing history information regarding frame-in direction and frame-out direction of an AR (Augmented Reality) marker 5 (see FIG. 6).

The AR marker 5 is an image for defining the information (for example, virtual object image) to be displayed in a screen of the display unit 14. Frame-in means that the AR marker 5 comes in to the screen of the display unit 14 from the state where there is no AR marker 5 in the screen when the picked up image obtained by the camera 16 is displayed in the screen of the display unit 14. Frame-out means that the AR marker 5 which is displayed in the screen of the display unit 14 disappears (goes out) from the screen when the picked up image obtained by the camera 16 is displayed in the screen of the display unit 14.

FIG. 2 shows an example of data storage in the frame-in/frame-out information storage unit 111. As shown in FIG. 2, the frame-in/frame-out information storage unit 111 has columns such as “order”, “movement” and “direction”, for example. In the column “order”, information regarding the order in which movements were performed is stored. In the column “movement”, information indicating whether a movement is frame-in or frame-out is stored. In the column “direction”, information indicating the direction of frame-in or frame-out is stored.

The storage unit 12 is formed of a HDD (Hard Disk Drive), a semiconductor non-volatile memory or the like. In the storage unit 12, a program storage unit 121 and a movement pattern data base 122 are provided as shown in FIG. 1, for example.

In the program storage unit 121, a system program and various types of process programs which are to be executed by the CPU 10, data needed to execute these programs, etc. are stored. For example, in the program storage unit 121, an AR marker application program is stored. These programs are stored in the program storage unit 121 in the form of program codes readable by a computer. The CPU 10 sequentially executes the operation according to the program codes.

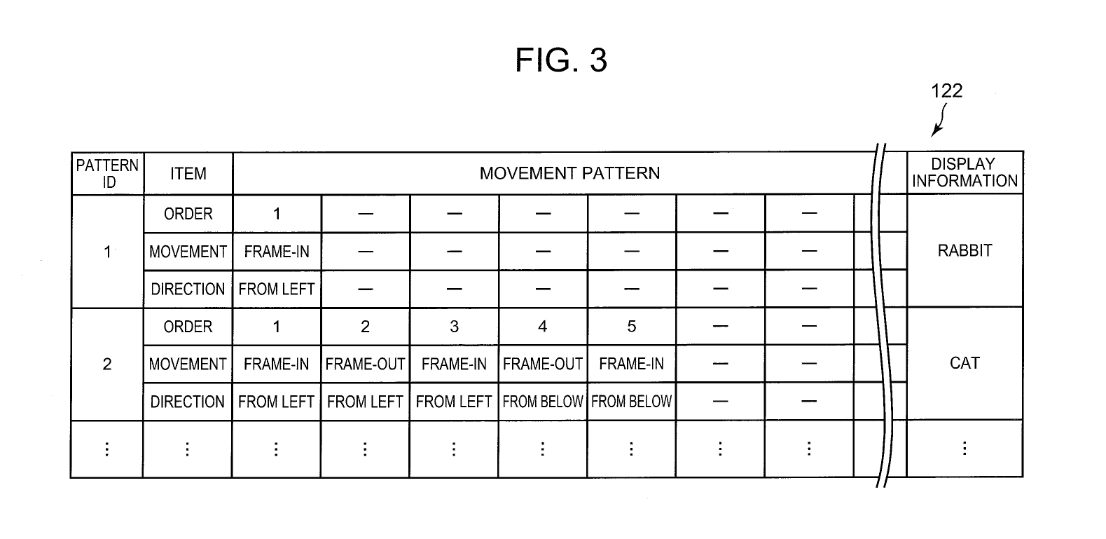

In the movement pattern data base 122, information regarding a series of movement patterns of frame-in/frame-out of an AR marker 5 and display information corresponding to each movement pattern (information indicating the content of display in the display unit 14 according to the movement pattern) are stored so as to be associated to each other as shown in FIG. 3. Movement pattern information includes individual movements constituting a series of movements (frame-in and frame-out), the order and their directions (for example, from the left, from the right, from above, from below). Here, since frame-out is a movement performed after frame-in, a frame-in movement has an odd number for its order and a frame-out movement has an even number for its order. Further, in the movement pattern database 122, individual movement patterns, each of which constituted only of the first frame-in from one of the frame-in directions, and their corresponding display information according to the frame-in directions are stores so as to be respectively associated.

Further, in the storage unit 12, a pattern file showing image patterns of the AR marker 5 is stored.

The communication unit 13 is formed of a LAN (Local Area Network) adapter, a router or the like, and performs data transmission and reception by being connected with an external apparatus via a communication network such as LAN or the like.

The display unit 14 is formed of a LCD (Liquid Crystal Display) or the like, and performs various types of displays on the screen according to display control signals from the CPU 10.

The operating unit 15 includes a cursor key, various types of functional keys, a shutter key, etc. The operating unit 15 receives push inputs of the above keys performed by a user and outputs their operation information to the CPU 10. The operating unit 15 also includes a touch panel wherein transparent electrodes are arranged in a lattice so as to cover the surface of the display nit 14, for example. The operating unit 15 detects the positions where pushed by a finger, touch pen or the like and outputs the position information to the CPU 10 as operation information.

The camera 16 includes a lens, a diaphragm and an image pickup element such as a CCD (Charge Coupled Device), a CMOS (Complementary Metal Oxide Semiconductor) or the like. The camera 16 is an image pickup unit which forms an optical image of a subject on the image pickup element and outputs the optical image to the CPU 10 as an electric signal.

The current time obtaining unit 17 is formed of a RTC (Real Time Clock), for example. The current time obtaining unit 17 counts the current time and outputs the current time to the CPU 10.

### <Operation of Image Processing Device 1>

Next, operation of the image processing device 1 according to the embodiment will be described.

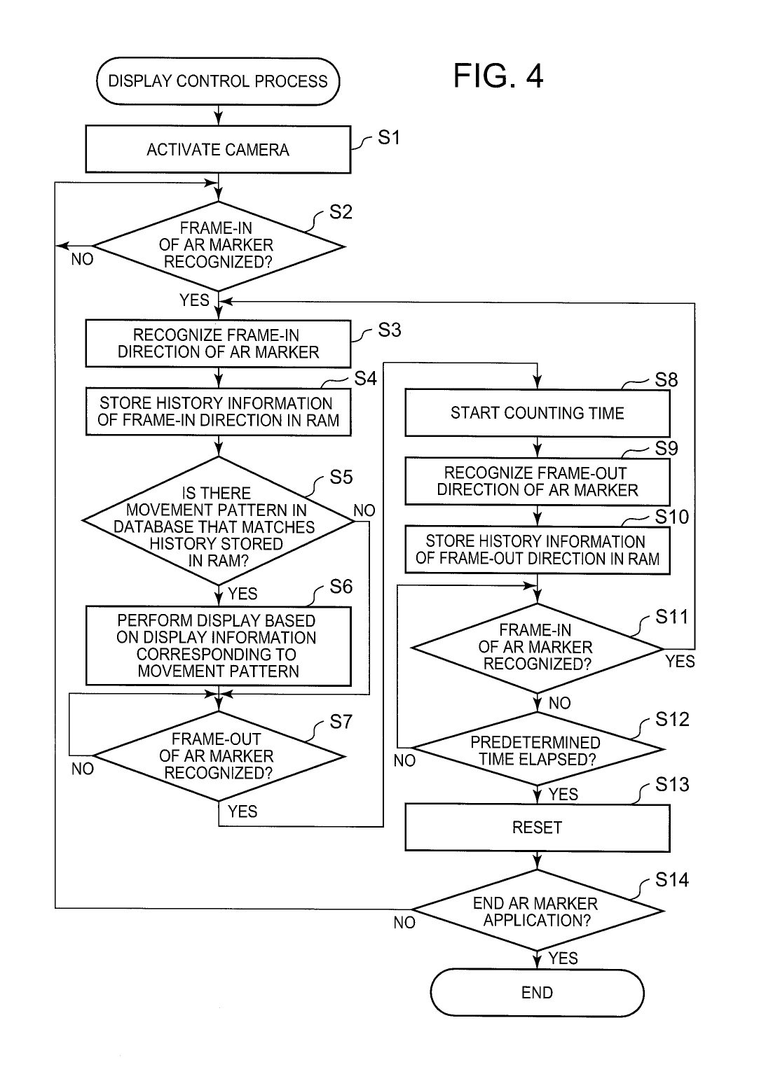

FIG. 4 shows a flowchart of a display control process which is executed by the image processing device 1. When activation of the AR marker application is instructed through the operating unit 15, the display control process is executed by the CPU 10 cooperating with the AR marker application program stored in the program storage unit 121.

First, the CPU 10 activates the camera 16 (step S1). After the camera 16 is activated and while the display control process is being executed, the camera 16 obtains a pickup image every predetermined time. The CPU 10 stores a picked up image obtained by the camera 16 in the RAM 11 so as to be associated with the current time obtained by the current time obtaining unit 17 and displays the picked up image on the screen of the display unit 14 in approximately real time.

Next, the CPU 10 waits for frame-in of an AR marker 5 to be recognized (step S2). In particular, the CPU 10 performs a recognition process regarding an AR marker 5 according to image processing with respect to each picked up image obtained every predetermined time by the camera 16. The AR marker 5 recognition process can be performed by a well-known method. For example, a rectangular region of a black frame is recognized in a picked up image, the image pattern in the black framed region is compared to the pattern file of the AR marker 5 stored in the storage unit 12, and if the matching rate is a predetermined threshold or greater, an AR marker 5 is recognized. When switched to the AR marker 5 recognized state from the AR marker 5 not-recognized state, the CPU 10 recognizes frame-in of the AR marker 5.

When frame-in of the AR marker 5 is recognized (step S2; YES), the CPU 10 obtains the trajectory of the coordinates of the AR marker 5 on the basis of a plurality of picked up images obtained by the camera 16 after frame-in of the AR marker 5 is recognized and recognizes the frame-in direction of the AR marker 5 on the basis of the obtained trajectory (step S3).

In particular, first, the CPU 10 sets the X axis, Y axis and the coordinates of the point of origin O (0,0) on a picked up image. Next, as shown in FIG. 5, with respect to the picked up image in which the AR marker 5 is recognized and n pieces of picked up images which are obtained after the picked up image in which the AR marker 5 is recognized by the camera 16 with predetermined time intervals, center coordinates P1 (X,Y), P2 (X,Y) . . . Pn (X,Y) of the AR marker 5 are obtained, and a regression curve L is drawn with the obtained center coordinates group. Then, the side E (a side of the screen frame of the display unit 14) which intercepts with the regression curve L at the position nearest from the center coordinates P1 (X,Y) of the picked up image in which the AR marker 5 is recognized is recognized as the side from where the AR marker 5 framed-in. Further, the direction of the side from where the AR marker 5 framed-in is recognized as the frame-in direction of the AR marker 5. For example, if the side from where the AR marker 5 framed-in is the left side, it is recognized that the frame-in direction of the AR marker 5 is “from the left”.

Next, the CPU 10 stores history information regarding the direction from which the AR marker 5 framed-in in the frame-in/frame-out information storage unit 111 (step S4).

Next, the CPU 10 determines whether a movement pattern that matches the history stored in the frame-in/frame-out information storage unit 111 of the RAM 11 is stored in the movement pattern database 122 (step S5).

If it is determined that a movement pattern that matches the history stored in the frame-in/frame-out information storage unit 111 is stored in the movement pattern database 122 (step S5; YES), the CPU 10 makes the display unit 14 perform a display on the basis of the display information stored in the movement pattern database 122 that is associated with the matching movement pattern (step S6). That is, the display unit 14 is made to perform a predetermined display according to the history of frame-in direction and frame-out direction of the AR marker. For example, at the position of the AR marker 5 in the picked up image displayed in the display unit 14, a virtual object image according to the movement pattern is combined to be displayed.

If it is determined that a movement pattern that matches the history stored in the frame-in/frame-out information storage unit 111 is not stored in the movement pattern database 122 (step S5; NO), the CPU 10 moves on to the process of step S7. That is, the information which is currently displayed continues to be displayed as is.

As described above, in the movement pattern database 122, individual movement patterns, each of which constituted only of the first frame-in from one of the frame-in directions, and their corresponding display information according to the frame-in directions are stored so as to be respectively associated. Therefore, when frame-in is recognized for the first time since the initial state, a predetermined display according to the frame-in direction of the AR marker 5 is to be performed.

Next, the CPU 10 waits for frame-out of the AR marker 5 to be recognized (step S7). During this waiting, the CPU 10 performs the above described AR marker 5 recognizing processing on each picked up image obtained by the camera 16 every predetermined time, and when the AR marker 5 is not recognized, the CPU 10 recognizes that the AR marker 5 framed-out.

When frame-out of the AR marker 5 is recognized (step S7; YES), the CPU 10 starts timing by the internal clock (step S8). Further, the CPU 10 obtains a trajectory of coordinates of the AR marker 5 on the basis of a plurality of picked up images obtained before frame-out of the AR marker 5 is recognized by the camera 16 and recognizes the direction in which the AR marker 5 framed out on the basis of the obtained trajectory (step S9). In particular, as shown in FIG. 5, the CPU 10 obtains center coordinates P11 (X,Y), P12 (X,Y) . . . P1n (X,Y) of the AR marker 5 in the n pieces of picked up images before the AR marker 5 is not recognized which are stored in the RAM 11 and draws the regression curve L with the obtained group of center coordinates. Next, the side E (a side of the screen frame of the display unit 14) which intercepts with the regression curve L at the position nearest to the center coordinates P11 (X,Y) just before the AR marker 5 stops being recognized is recognized as the side from where the AR marker 5 framed out. Further, the direction of the side from where the AR marker 5 framed out is recognized as the frame-out direction of the AR marker 5. For example, if the left side is recognized as the side from where the AR marker 5 framed out, it is recognized that the frame-out direction of the AR marker 5 is “from the left”.

Next, the CPU 10 stores the history information regarding the frame-out direction in the frame-in/frame-out information storage unit 111 of the RAM 11 (step S10).

Next, the CPU 10 performs the AR marker 5 recognition process on the picked up image after the AR marker 5 is framed out and determines whether frame-in of the AR marker 5 is recognized (step S11). If it is determined that frame-in of the AR marker 5 is recognized (step S11; YES), the CPU 10 returns to the process of step S3 and repeats the processes from step S3 through step S11.

If it is determined that frame-in of the AR marker 5 is not recognized (step S11; NO), the CPU 10 determines whether a predetermined time elapsed since the time counting started (that is, since the AR marker 5 framed out) (step S12).

If it is determined that a predetermined time has not elapsed since the time counting started (that is, since the AR marker 5 framed out) (step S12; NO), the processing returns to step S11.

If it is determined that a predetermined time has elapsed since the time counting started (that is, since the AR marker 5 framed out) (step S12; YES), the CPU 10 resets (deletes) the picked up images stored in the RAM 11 and the history information stored in the frame-in/frame-out information storage unit 111 (step S13). In such way, the processing is initialized.

The processes from step S2 through step S13 are repeated until the end instruction of the AR marker application is input via the operating unit 15. When the end instruction of the AR marker application is input via the operating unit 15 (step S14; YES), the CPU 10 ends the display control processing.

The display operation according to the above described display control processing will be described with a specific example shown in FIG. 6.

For example, if the image processing device 1 is moved to the left in the initial state shown in FIG. 6A, the AR marker 5 frames in from the left as shown in FIG. 6B. The movement history from the initial state up to here (framing in from the left) matches the movement pattern stored in the movement pattern database 122 as shown in FIG. 3. Therefore, according to the display information (rabbit) associated with this movement pattern, an image of a rabbit is displayed at the position of the AR marker 5.

Next, if the image processing device 1 is moved to the right, the AR marker 5 frames out from the left as shown in FIG. 6C. From this state, if the image processing device 1 is moved to the left, the AR marker 5 frames in from the left as shown in FIG. 6D. The movement history from the initial state up to here (frame-in from the left→frame-out from the left→frame-in from the left) is not stored in the movement pattern database 122. Therefore, the rabbit continues to be displayed on the AR marker 5.

Next, if the image processing device 1 is moved upward, the AR marker 5 frames out downward as shown in FIG. 6E. From this state, if the image processing device 1 is moved downward, the AR marker 5 frames in from below as shown in FIG. 6F. Here, the movement history from the initial state up to here (frame-in from the left→frame-out from the left→frame-in from the left frame-out from below→frame-in from below) matches with a movement pattern stored in the movement pattern database 122. Therefore, according to the display information (cat) associated with this movement pattern, an image of a cat is displayed at the position of the AR marker 5.

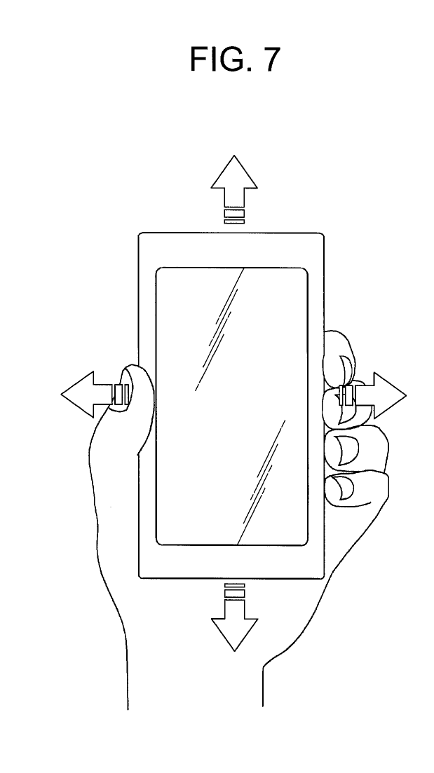

In such way, by merely making one AR marker 5 frame-in or frame-out according to a movement pattern registered in the movement pattern database 122 by moving the image processing device 1 in the up, down, left and right directions as shown in FIG. 7, a desired display according to the movements can be carried out in the display unit 14.

As described above, according to the image processing device 1 of the embodiment, based on picked up images from the camera 16, the CPU 10 recognizes that the AR marker 5 framed in the screen of the display unit 14 and also recognizes the direction from which the AR marker 5 framed in. Further, the CPU 10 makes the display unit 14 perform a predetermined display according to the frame-in direction of the AR marker 5.

Therefore, even if there is one AR marker 5, the display unit 14 can be made to carry out a plurality of different displays according to the frame-in directions of the AR marker 5. As a result, there is no need to perform selection operation to select the type of AR marker and leads to improvement in user friendliness.

Further, the CPU 10 stores the history information regarding the frame-in directions and the frame-out directions of the AR marker 5 in the frame-in/frame-out information storage unit 111. When frame-in of the AR marker 5 is recognized, the CPU 10 makes the display unit 14 perform a predetermined display according to the history of the frame-in directions and frame-out directions of the AR marker 5 which are stored in the frame-in/frame-out information storage unit 111.

Therefore, even if there is one AR marker 5, a plurality of different displays can be carried out in the display unit 14 according to a series of movements of frame-in directions and frame-out directions of the AR marker 5. As a result, there is no need to perform selection operation to select the type of AR marker and leads to improvement in user friendliness.

Further, the CPU 10 uses the image processing technique to recognize the frame-in directions and the frame-out directions of the AR marker 5. Therefore, such recognition can be realized with a simple device configuration without having a hardware such as an acceleration sensor or the like being mounted.

Here, the description of the above embodiment is a preferred example of an image processing device and is not limitative in any way.

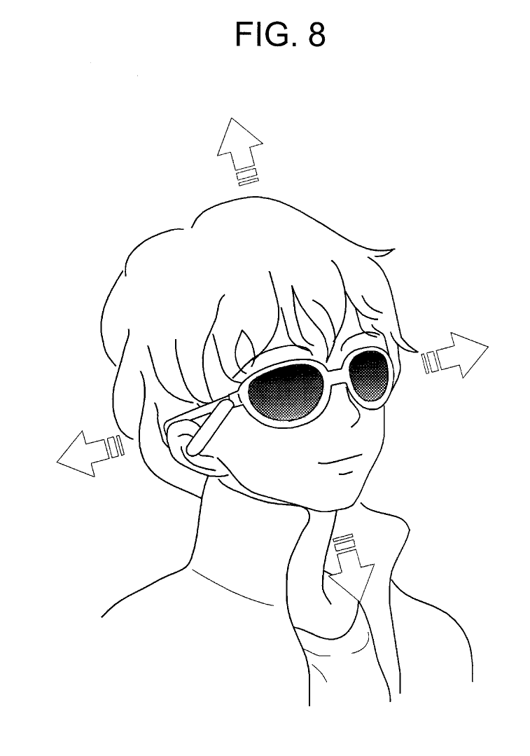

For example, in the above embodiment, a description is given by taking the case where the image processing device 1 is a portable terminal to be held in a hand, such as a smartphone, as an example. However, the image processing device 1 may be eyeglasses type HMD (Head Mounted Display) or the like. In such case, frame-in and frame-out of a marker can be performed with shaking of the head as shown in FIG. 8. Therefore, display in the display unit 14 can be switched hands-free.

Further, in the embodiment, display information is made to be associated in advance with each movement pattern where frame-in and frame-out from various directions are combined. However, for example, display information may be stored by being associated with a movement pattern only including frame-in (for example, frame-in from the right→frame-in from the left→frame-in from above . . . ). When frame-in of the AR marker 5 is recognized, the CPU 10 determines whether the history of frame-in directions of the AR marker 5 matches a movement pattern which is stored in advance. If there is a match, the CPU 10 makes the display unit 14 perform a display on the basis of the display information according to the movement pattern. Further, for example, display information may be stored by being associated with a movement pattern only including frame-out (for example, frame-out from the right frame-out from the left frame-out from above . . . ). When frame-in of the AR marker 5 is recognized, the CPU 10 determines whether the history of frame-out directions of the AR marker 5 up to this point matches a movement patter stored in advance. If there is a match, the display unit 14 carries out a display on the basis of the display information corresponding to the movement pattern.

Moreover, in the embodiment, if the history of a series of movements consists of frame-in and frame-out from the initial state matches a movement pattern stored in the movement pattern database 122, display is carried out according to the movement pattern. However, the present invention is not limited to this.

For example, frame-in directions and their associated display information, which are made to be associated in advance, may be stored in the storage unit 12, and the CPU 10 may make the display unit 14 perform a predetermined display according to the direction from which the AR marker 5 framed in on the basis of the display information which is pre-associated to the direction of the recognized frame-in every time the frame-in direction of the AR marker 5 is recognized.

Further, for example, frame-out directions and their associated display information, which are made to be associated in advance, may be stored in the storage unit 12, and when the CPU 10 recognizes the frame-out direction of the AR marker 5, the CPU 11 may store the recognized direction in the RAM 11 and when the CPU 10 recognizes the frame-in direction of the AR marker 5, the CPU 10 may make the display unit 14 perform a predetermined display according to the frame-out direction of the AR marker 5 just before the recognized frame-in on the basis of the display information pre-associated to the frame-out direction which is recognized just before the recognized frame-in.

Moreover, for example, frame-out directions and their corresponding display information, which are made to be associated in advance, may be stored in the storage unit 12, and when the CPU 10 recognizes the frame-out direction of the AR marker 5, the display information associated with the frame-out direction may be displayed. At this time, since display information is displayed with the frame-out of the marker 5 being the trigger, thereafter, display information can be displayed even if the marker 5 does not frame-in.

Even in such way, even if there is one AR marker 5, the display unit 14 can be made to carry out a plurality of different displays according to the frame-in or frame-out directions of the AR marker 5 similarly to the above embodiment.

Moreover, in the above embodiment, frame-in directions and frame-out directions of the AR marker 5 are recognized by the image processing technique. However, if the image processing device 1 has an acceleration sensor or a gyro sensor mounted thereon, frame-in directions and frame-out directions may be recognized by it.

Further, in the above embodiment, description is given for a display based on one AR marker 5. However, there may be a plurality of types of AR markers. In such case, a plurality of movement pattern databases 122 are stored for individual types of AR marker, and the display control processing is performed by using the movement pattern database according to the AR pattern type which is recognized.

Furthermore, not only the frame-in directions and the frame-out directions of the AR marker 5, but also the time required from frame-in to frame-out may be used as a parameter to control the display content.

As for a computer readable medium storing programs for executing the above described processing, other than a ROM, a hard disk or the like, a non-volatile memory such as a flash memory or a portable recording medium such as a CD-ROM can be used. Further, as for a medium which provides data of programs via a predetermined communication line, a carrier wave can also be used.

With respect to detail configuration and detail operation of each device that constitutes the image processing device, they can be modified arbitrarily within the scope of the invention.

Although various exemplary embodiments have been shown and described, the scope of the invention is not limited to the above described embodiments and includes the scope of the invention described in the claims and their equivalents.

The entire disclosure of Japanese Patent Application No. 2013-129368 filed on Jun. 20, 2013 is incorporated herein by reference in its entirety.

What is claimed is:

1. An image processing device, comprising:
an image pickup unit;
a display unit which displays a picked up image obtained by the image pickup unit;
a frame-in frame-out recognition unit which recognizes that a predetermined marker framed-in in or framed-out from a screen of the display unit;
a frame-in frame-out direction recognition unit which recognizes a frame-in direction or a frame-out direction of the marker; and
a control unit which makes the display unit perform a predetermined display according to the frame-in direction or the frame-out direction of the marker.

2. The image processing device according to claim 1 further comprising:
a frame-out recognition unit which recognizes that the marker framed-out from the screen of the display unit;
a frame-out direction recognition unit which recognizes a frame-out direction of the marker; and
a storage unit which stores history information of the frame-in direction and the frame-out direction of the marker,
wherein
the control unit makes the display unit perform a predetermined display according to the history of the frame-in direction and the frame-out direction of the marker stored in the storage unit when frame-in of the marker is recognized after frame-out of the marker is recognized.

3. The image processing device according to claim 1, further comprising:
a storage unit which stores the frame-out direction of the marker; and
a control unit which makes a display unit perform a predetermined display according to the frame-out direction of the marker stored in the storage unit when frame-in of the marker is recognized after frame-out of the marker is recognized.
wherein
the frame-in frame-out recognition unit recognizes that a predetermined marker framed-in in and framed-out from a screen of the display unit; and
the frame-in frame-out direction recognition unit recognizes the frame-in direction and the frame-out direction of the marker

4. The image processing device according to claim 1, wherein
the frame-in frame-out direction recognition unit obtains a trajectory of coordinates of the marker after frame-in of the marker is recognized on a basis of a plurality of picked up images obtained by the image pickup unit after frame-in of the marker is recognized, and the frame-in direction recognition unit recognizes the frame-in direction of the marker on the basis of the obtained trajectory.

5. The image processing device according to claim 2, wherein
the frame-in frame-out direction recognition unit obtains a trajectory of coordinates of the marker after frame-in of the marker is recognized on a basis of a plurality of picked up images obtained by the image pickup unit after frame-in of the marker is recognized, and the frame-in direction recognition unit recognizes the frame-in direction of the marker on a basis of the obtained trajectory.

6. The image processing device according to claim 2, wherein
the frame-out direction recognition unit obtains a trajectory of coordinates of the marker just before frame-out of the marker is recognized on a basis of a plurality of picked up images obtained by the image pickup unit before frame-out of the marker is recognized, and the frame-out direction recognition unit recognizes the frame-out direction of the marker on a basis of the obtained trajectory.

7. A non-transitory computer readable medium which stores a program to make a computer included in an image processing device comprising an image pickup unit and a display unit which displays a picked up image obtained by the image pickup unit execute:
a frame-in frame-out recognition process to recognize that a predetermined marker framed-in in or framed-out from a screen of the display unit;
a frame-in frame-out direction recognition process to recognize a frame-in direction or a frame-out direction of the marker; and
a control process to make the display unit perform a predetermined display according to the frame-in direction or the frame-out direction of the marker.
